(19) United States
(12) Patent Application Publication
(10) Pub. No.: US 2003/0218280 A1
(43) Pub. Date: Nov. 27, 2003

(54) End attachment component for air springs that require no leak test

(76) Inventor: Joe Morow, Mesa, AZ (US)

Correspondence Address: CHASSIS TECH / JOE MORROW, 260 S. HIBBERT ST, MESA, AZ, 85210, US

(21) Appl. No.: 10/152,229

(22) Filed: May 21, 2002

(51) Int. Cl. F16F 5/00

(52) U.S. Cl. 267/64.11

(57) ABSTRACT

The invention relates to the automotive and light truck industries where air springs are used in aftermarket suspension. Specifically to that of manufacturing end attachment components from stamped steel with the threaded fasteners that are used for mounting the finished product, melted in to place instead of brazed. It also incorporates a port used to pressurize and depressurize the air bellow that has been stamped into the end attachment component. The invention of this new end attachment component requires no leak test, takes less effort to manufacturer, and is more cost effective.

### 1. TECHNICAL FIELD

This invention pertains to the steel end attachment components used on air springs in the automotive and light truck suspension market. Previously these end attachment components have been composed of one or two threaded fasteners used for mounting the finished product on to it application. The threaded fasteners are attached to the end attachment component by brazing the parts together with a filler material.

The end attachment component also has an air port that usually consist of ¼″ or ⅜″ NPT used to pressurize and depressurize the air bellow. This port is also brazed on to the steel end attachment component using a filler material. Both of these techniques cost the manufacturer more to build and require the manufacturer to leak test all parts.

The invention incorporates an end attachment component with one or two threaded fasteners used for mounting the finished product on to its application. The threaded fasteners are attached to the top of the steel end attachment component by using equipment, which melts the two parts together. This invention also incorporates a port used to pressurize and depressurize the air bellow, where previously it has been brazed on leaving it susceptible to leakage. The invention incorporates an air port that has been stamped into the steel end attachment component and then threaded. This new invention makes the end attachment component into one single piece therefore requiring no leak test and improving productivity.

### 2. BACK GROUND OF PRIOR ART

Air springs or air bellows having a flexible member of elastomeric material have been proven for decades as load and height controllable springs in the automotive and light truck industries. The industry has a different number of end attachment components. This invention pertains to the most common and widely used method. This method is when the air bellows are sealed off at each end by crimping an end attachment component constructed from stamped steel onto the bead-sealing ring of the air bellow.

This type of end attachment component is very dependable and has been proven for years in the air bellow aftermarket industry. However the air bellow aftermarket industry only offers end attachment components that have brazed threaded fasteners used for mounting the final product and brazed ports used to pressurize and depressurize the air bellow. These end attachment components require that the manufacturer perform a leak test. These end attachment components are manufactured by having a number of holes punched of a size accordingly to accommodate the threaded fasteners and or the threaded air port.

The threaded fasteners and air port bungs are then inserted into the end attachment component and brazed in place using a filler material. This process requires the manufacturer to leak test all end attachment components before assembling, therefore making the product less reliable and less cost effective.

### SUMMARY OF INVENTION

The objective of this invention is to provided end attachment components, which are more dependable and will require no leak test. The end attachment components are to be constructed from stamped steel. The threaded fasteners used for mounting the finished product are to be melted into place using a special machine. The air ports used to pressurize and depressurize the air bellows is to be stamped into the end attachment components and then threaded. By incorporating these two new features onto our new end attachment component we will make the product more reliable and cost effective.

### BRIEF DESCRIPTION OF DRAWINGS

FIG. 1 is a side and top view drawing of the new crimp on end attachment component with the threaded fasteners melted on to the end attachment component. It also shows the air port stamped into the end attachment component and threaded accordingly.

FIG. 2 is a section view drawing of the end attachment component shown in FIG. 1.

### DETAILED DESCRIPTION OF THE PREFERRED EMBODIMENTS

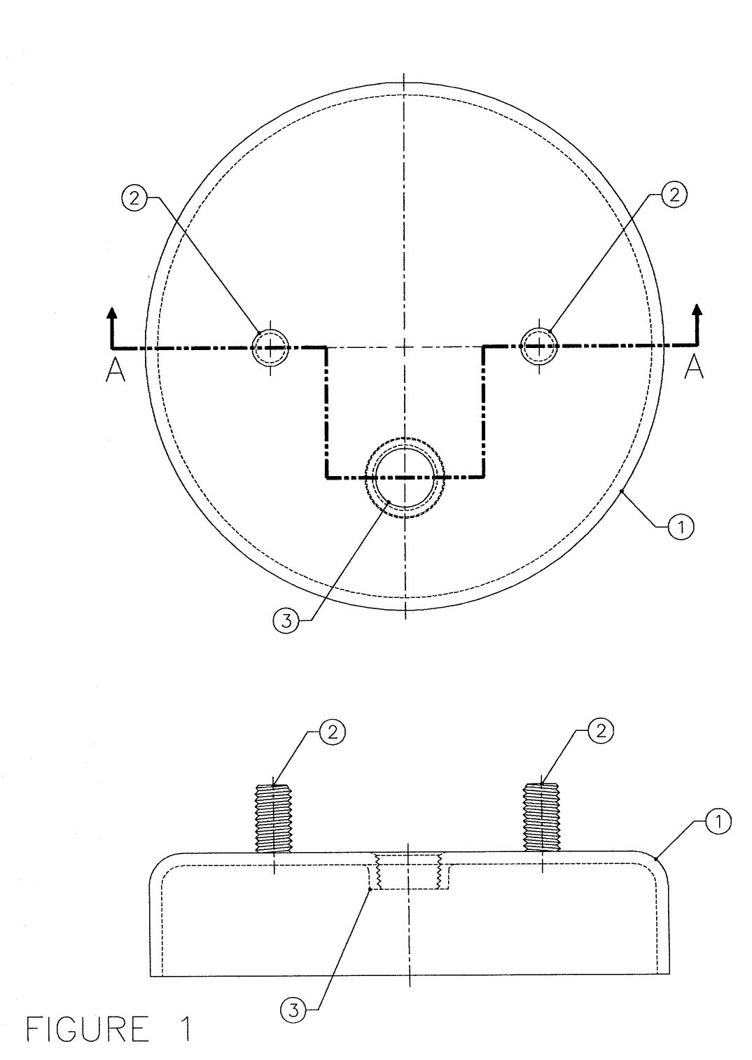

Referring to FIG. 1, The end attachment component (1) is shown prior to being crimped on to an air spring. This end attachment component (1) has two threaded fasteners (2) melted on to the top of the end attachment component (1). The two threaded fasteners (2) are used for mounting the finished product on to its application. The end attachment component (1) also has one or more threaded air port (3) stamped on to the top of the end attachment component (1).

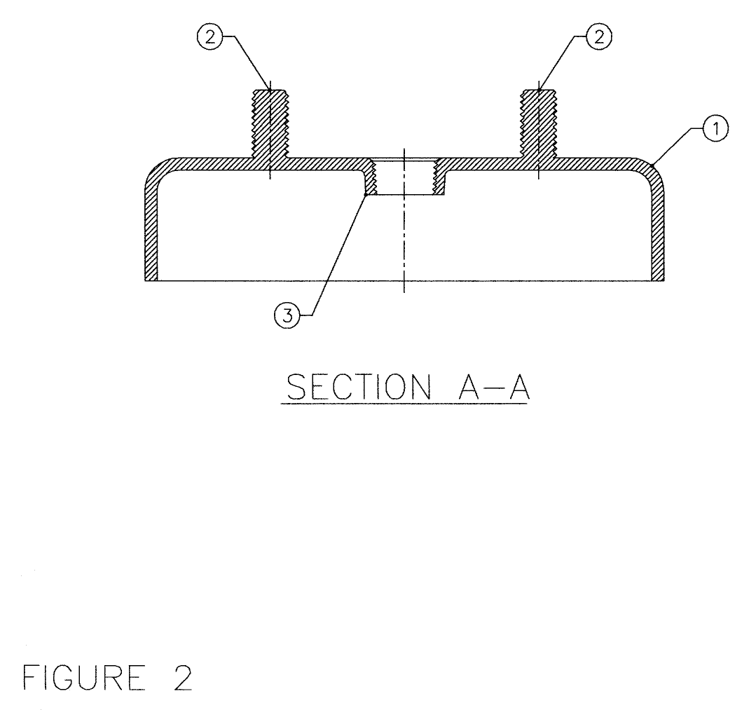

Referring to FIG. 2, This is a section view of the end attachment component (1) shown in FIG. 1. This section view clearly shows how the two threaded fasteners (2) which are melted to the top of the end attachment component (1) become one with this part. The same goes for the threaded air port (3), which is stamped onto the end attachment component (1) and will also require no leak test. The finished product becomes a single part.

What is claimed:

1. An end attachment component comprising:
A design where the threaded fasteners used for mounting the products are melted on to the top of the end attachment component rather than having a hole punched, the fastener inserted and then brazed with a filler material therefore requiring a leak test.

2. An end attachment component comprising:
A design where the threaded air port is stamped into the top of the end attachment component rather than it being a bung type which is brazed with a filler material and will require a leak test.
